(19) United States
(12) Patent Application Publication
(10) Pub. No.: US 2006/0141143 A1
(43) Pub. Date: Jun. 29, 2006

(54) Method for creating circuit assemblies

(76) Inventors: Gregory J. McCollum, Gibsonia, PA (US); Thomas C. Moriarity, Allison Park, PA (US); Kevin C. Olson, Wexford, PA (US); Michael G. Sandala, Pittsburgh, PA (US)

Correspondence Address: PPG INDUSTRIES, INC.;Law Dept. - Intellectual Property, One PPG Place, Pittsburgh, PA, 15272, US

(21) Appl. No.: 11/280,376

(22) Filed: Nov. 16, 2005

Related U.S. Application Data
(60) Provisional application No. 60/637,320, filed on Dec. 17, 2004.

(51) Int. Cl. B05D 5/06

(52) U.S. Cl. 427/164

(57) ABSTRACT

Provided is a method for preparing a circuit assembly. The method includes (a) applying a curable coating composition to a substrate, the curable coating composition formed from (i) one or more active hydrogen-containing resins, (ii) one or more polyester curing agents, and (iii) optionally, one or more transesterification catalysts; (b) curing the curable coating composition to form a coating on the substrate; and (c) applying a conductive layer to the surface of at least part of said cured composition. A circuit assembly prepared by the method also is provided.

### CROSS-REFERENCE TO RELATED APPLICATIONS

This application claims the benefit of priority of U.S. Provisional Patent Application No. 60/637,320, filed Dec. 17, 2004.

### FIELD OF THE INVENTION

The present invention relates to methods for fabricating electrical circuit assemblies.

### BACKGROUND OF THE INVENTION

Electrical components, for example, resistors, transistors, and capacitors, are commonly mounted on circuit panel structures such as printed circuit boards. Circuit panels ordinarily include a generally flat sheet of dielectric material with electrical conductors disposed on a major, flat surface of the sheet, or on both major surfaces. The conductors are commonly formed from metallic materials such as copper and serve to interconnect the electrical components mounted to the board. Where the conductors are disposed on both major surfaces of the panel, the panel may have via conductors extending through holes (or “through vias”) in the dielectric layer so as to interconnect the conductors on opposite surfaces. Multi-layer circuit panel assemblies have been made heretofore which incorporate multiple stacked circuit panels with additional layers of dielectric materials separating the conductors on mutually facing surfaces of adjacent panels in the stack. These multi-layer assemblies ordinarily incorporate interconnections extending between the conductors on the various circuit panels in the stack as necessary to provide the required electrical interconnections.

In microelectronic circuit packages, circuits and units are prepared in packaging levels of increasing scale. Generally, the smallest scale packaging levels are typically semiconductor chips housing multiple microcircuits and/or other components. Such chips are usually made from ceramics, silicon, and the like. Intermediate package levels (i.e., “chip carriers”) comprising multi-layer substrates may have attached thereto a plurality of small-scale chips housing many microelectronic circuits. Likewise, these intermediate package levels themselves can be attached to larger scale circuit cards, motherboards, and the like. The intermediate package levels serve several purposes in the overall circuit assembly including structural support, transitional integration of the smaller scale microcircuits and circuits to larger scale boards, and the dissipation of heat from the circuit assembly. Substrates used in conventional intermediate package levels have included a variety of materials, for example, ceramic, fiberglass reinforced polyepoxides, and polyimides.

The aforementioned substrates, while offering sufficient rigidity to provide structural support to the circuit assembly, typically have thermal coefficients of expansion much different than that of the microelectronic chips being attached thereto. As a result, failure of the circuit assembly after repeated use is a risk due to failure of adhesive joints between the layers of the assembly.

Likewise, dielectric materials used on the substrates must meet several requirements, including conformality, flame resistance, and compatible thermal expansion properties. Conventional dielectric materials include, for example, polyimides, polyepoxides, phenolics, and fluorocarbons. These polymeric dielectrics typically have thermal coefficients of expansion much higher than that of the adjacent layers.

There has been an increasing need for circuit panel structures, which provide high density, complex interconnections. In applications wherein circuit layers are built one on top of another, a dielectric material typically separates the circuitized layers. Polymeric dielectric materials that typically are used in circuit assembly manufacture are thermoplastic or thermoset polymers. Thermoset materials are typically cured first to form a conformal coating. As density and complexity of interconnected circuitry increases, there is an increasing need for dielectric materials with increasingly lower dielectric constants and dielectric loss factors.

### SUMMARY OF THE INVENTION

The present invention is directed toward a method for preparing a circuit assembly. The method comprises: (a) applying a curable coating composition to a substrate, (b) curing the coating composition to form a coating on the substrate, and (c) applying a conductive layer to all surfaces. The curable coating composition is comprised of (i) one or more ungelled active hydrogen-containing resins, (ii) one or more polyester curing agents, and (iii) optionally one or more transesterification catalysts. In a further embodiment, the method also comprises: (d) applying a resist to the conductive layer applied in step (c), (e) processing said resist to form a predetermined pattern of exposed underlying metal, (f) etching said exposed metal, and (g) stripping the remaining second resist to form an electrical circuit pattern.

### DETAILED DESCRIPTION OF THE INVENTION

Other than in the operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between and including the recited minimum value of 1 and the recited maximum value of 10, that is, having a minimum value equal to or greater than 1 and a maximum value of equal to or less than 10.

As previously mentioned, in one embodiment, the present invention is directed to a method for preparing a circuit assembly. The method comprises: (a) applying a curable coating composition to a substrate, (b) curing the curable coating composition to form a coating on the substrate, and (c) applying a conductive layer to all surfaces. The curable coating composition is comprised of (i) one or more ungelled active hydrogen-containing resins, (ii) one or more polyester curing agents, and (iii) optionally one or more transesterification catalysts.

The curable coating compositions useful in the methods of the present invention comprise as a main film-former, an ungelled, active hydrogen-containing resin (i). A wide variety of film-forming polymers are known and can be used in the curable coating compositions of the present invention provided they comprise active hydrogen groups, as determined by the Zerewitinoff test, described in the JOURNAL OF THE AMERICAN CHEMICAL SOCIETY, Vol. 49, page 3181 (1927). In one embodiment, the active hydrogens are derived from hydroxyl groups, thiol groups, primary amine groups and/or secondary amine groups.

By “ungelled” is meant the resins are substantially free of crosslinking and have an intrinsic viscosity when dissolved in a suitable solvent, as determined, for example, in accordance with ASTM-D1795 or ASTM-D4243. The intrinsic viscosity of the reaction product is an indication of its molecular weight. A gelled reaction product, on the other hand, since it is of essentially infinitely high molecular weight, will have an intrinsic viscosity too high to measure. As used herein, a reaction product that is “substantially free of crosslinking” refers to a reaction product that has a weight average molecular weight (Mw), as determined by gel permeation chromatography, of less than 1,000,000.

A variety of active hydrogen-containing resin materials are suitable for use in the present invention. Non-limiting examples of suitable resins include: polyepoxide polymers, acrylic polymers, polyester polymers, urethane polymers, silicon-based polymers; polyether polymers, polyurea polymers, vinyl polymers, polyamide polymers, polyimide polymers, mixtures thereof and copolymers thereof. As used herein, by “silicon-based polymers” is meant a polymer comprising one or more —SiO— units in the backbone. Such silicon-based polymers can include hybrid polymers, such as those comprising organic polymeric blocks with one or more —SiO— units in the backbone.

The polymer is typically a water-dispersible, electrodepositable film-forming polymer. The water-dispersible polymer may be ionic in nature; that is, the polymer can contain anionic functional groups to impart a negative charge or cationic functional groups to impart a positive charge. Most often, the polymer contains cationic salt groups, usually cationic amine salt groups.

Non-limiting examples of film-forming resins suitable for use as the polymer in the composition of the present invention, in particular in anionic electrodepositable coating compositions, include base-solubilized, carboxylic acid group-containing polymers such as the reaction product or adduct of a drying oil or semi-drying fatty acid ester with a dicarboxylic acid or anhydride; and the reaction product of a fatty acid ester, unsaturated acid or anhydride and any additional unsaturated modifying materials which are further reacted with polyol. Also suitable are the at least partially neutralized interpolymers of hydroxy-alkyl esters of unsaturated carboxylic acids, unsaturated carboxylic acid and at least one other ethylenically unsaturated monomer. Still another suitable electrodepositable resin comprises an alkyd-aminoplast vehicle, i.e., a vehicle containing an alkyd resin and an amine-aldehyde resin. Another suitable anionic electrodepositable resin composition comprises mixed esters of a resinous polyol. These compositions are described in detail in U.S. Pat. No. 3,749,657 at col. 9, lines 1 to 75 and col. 10, lines 1 to 13. Other acid functional polymers also can be used such as phosphatized polyepoxide or phosphatized acrylic polymers as are well known to those skilled in the art. Additionally, suitable for use as the polymer are those resins comprising one or more pendent carbamate functional groups, for example, those described in U.S. Pat. No. 6,165,338.

In one particular embodiment of the present invention, the polymer is a cationic, active hydrogen-containing ionic electrodepositable resin capable of deposition on a cathode. Non-limiting examples of such cationic film-forming resins include amine salt group-containing resins such as the acid-solubilized reaction products of polyepoxides and primary or secondary amines such as those described in U.S. Pat. Nos. 3,663,389; 3,984,299; 3,947,338; and 3,947,339. Besides the epoxy-amine reaction products discussed immediately above, the polymer can also be selected from cationic acrylic resins such as those described in U.S. Pat. Nos. 3,455,806 and 3,928,157.

Besides amine salt group-containing resins, quaternary ammonium salt group-containing resins can also be employed. Examples of these resins include those which are formed from reacting an organic polyepoxide with a tertiary amine salt. Such resins are described in U.S. Pat. Nos. 3,962,165; 3,975,346; and 4,001,101. Examples of other cationic resins are ternary sulfonium salt group-containing resins and quaternary phosphonium salt group containing resins such as those described in U.S. Pat. Nos. 3,793,278 and 3,984,922, respectively. Also, film-forming resins such as described in European Application No. 12463 can be used. Further, cationic compositions prepared from Mannich bases such as described in U.S. Pat. No. 4,134,932 can be used.

In one embodiment of the present invention, the polymer can comprise one or more positively charged resins which contain primary and/or secondary amine groups. Such resins are described in U.S. Pat. Nos. 3,663,389; 3,947,339; and 4,116,900. In U.S. Pat. No. 3,947,339, a polyketimine derivative of a polyamine such as diethylenetriamine or triethylenetetraamine is reacted with a polyepoxide. When the reaction product is neutralized with acid and dispersed in water, free primary amine groups are generated. Also, equivalent products are formed when a polyepoxide is reacted with excess polyamines such as diethylenetriamine and triethylenetetraamine and the excess polyamine vacuum stripped from the reaction mixture. Such products are described in U.S. Pat. Nos. 3,663,389 and 4,116,900.

Mixtures of the above-described ionic resins also can be used advantageously. In one embodiment of the present invention, the polymer has cationic salt groups and is selected from a polyepoxide-based polymer having primary, secondary and/or tertiary amine groups (such as those described above) and an acrylic polymer having hydroxyl and/or amine functional groups.

As previously discussed, in one particular embodiment of the present invention, the polymer has cationic salt groups. In this instance, such cationic salt groups typically are formed by solubilizing the resin with an inorganic or organic acid such as those conventionally used in electrodepositable compositions. Suitable examples of solubilizing acids include, but are not limited to, sulfamic, acetic, lactic, and formic acids. In an embodiment of the invention the solubilizing acid comprises sulfamic acid and/or lactic acid.

In a particular embodiment, the coating compositions useful in the methods of the present invention comprise one or more components comprising covalently bonded halogen atoms. It should be understood that for purposes of the present invention, by “covalently bonded halogen atom” is meant a halogen atom that is covalently bonded as opposed to a halogen ion, for example, a chloride ion in aqueous solution.

The coating composition used in the methods of the present invention can have a covalently bonded halogen content of at least 1 weight percent, or at least 2 weight percent, or at least 5 weight percent, or at least 10 weight percent, based on total weight of resin solids. Also, the coating composition used in the methods of the present invention can have a covalently bonded halogen content of less than or equal to 50 weight percent, or less than or equal to 30 weight percent, or less or equal to 25 weight percent, or less than or equal to 20 weight percent. The coating composition can have a covalently bonded halogen content which can range between any combination of these values, inclusive of the recited values.

In an embodiment of the present invention, the coating composition is an electrodepositable coating composition comprising a resinous phase dispersed in an aqueous medium. The covalently bonded halogen content of the resinous phase of the electrodepositable coating composition can be derived from halogen atoms covalently bonded to the resin (i). In such instances, the covalently bonded halogen content can be attributed to a reactant used to form any of the film-forming resins described above. For example, the resin may be the reaction product of a halogenated phenol, for example a halogenated polyhydric phenol such as chlorinated or brominated bisphenol A with an epoxy group-containing material such as those described above with reference to the resin (i). In the case of an anionic group-containing polymer, solubilization with phosphoric acid may follow. Alternatively, an epoxy containing compound reacted with a halogenated carboxylic acid followed by reaction of any residual epoxy groups with phosphoric acid would yield a suitable polymer. The acid groups can then be solubilized with amine. Likewise, in the case of a cationic salt group-containing polymer, the resin may be the reaction product of an epoxy functional material such as those described above with a halogenated phenol followed by reaction of any residual epoxy groups with an amine. The reaction product can then be solubilized with an acid.

In one embodiment of the present invention, the covalently bonded halogen content of the resin (i) can be derived from a halogenated compound selected from at least one of a halogenated phenol, halogenated polyepoxide, halogenated acrylic polymer, halogenated polyolefin, halogenated phosphate ester, and mixtures thereof. In another embodiment of the present invention, the covalently bonded halogen content of the resin (i) is derived from a halogenated polyhydric phenol, for example, a chlorinated bisphenol A such as tetrachlorobisphenol A, or a brominated bisphenol A such as tetrabromobisphenol A. Additionally, the covalently bonded halogen content may be derived from a halogenated epoxy compound, for example, the diglycidyl ether of a halogenated bisphenol A.

The active hydrogen-containing resin (i) described above can be present in the curable coating composition of the present invention in amounts ranging from 10 to 90 percent by weight, or 30 to 45 percent by weight based on total weight of the curable coating composition.

As previously discussed, the composition used in the methods of the present invention further comprises one or more polyester curing agents (ii). The polyester curing agent (ii) is a material having greater than one ester group per molecule. The ester groups are present in an amount sufficient to effect cross-linking at acceptable cure temperatures and cure times, for example at temperatures up to 250° C., and curing times of up to 90 minutes. It should be understood that acceptable cure temperatures and cure times will be dependent upon the substrates to be coated and their end uses.

Compounds generally suitable as the polyester curing agent (ii) are polyesters of polycarboxylic acids. Non-limiting examples include bis(2-hydroxyalkyl)esters of dicarboxylic acids, such as bis(2-hydroxybutyl) azelate and bis(2-hydroxyethyl)terephthalate; tri(2-ethylhexanoyl)trimellitate; and poly(2-hydroxyalkyl)esters of acidic half-esters prepared from a dicarboxylic acid anhydride and an alcohol, including polyhydric alcohols. The latter type is particularly suitable to provide a polyester with a final functionality of more than 2. One suitable example includes a polyester prepared by first reacting equivalent amounts of the dicarboxylic acid anhydride (for example, succinic anhydride or phthalic anhydride) with a trihydric or tetrahydric alcohol, such as glycerol, trimethylolpropane or pentaerythritol, at temperatures below 150° C., and then reacting the acidic polyester with at least an equivalent amount of an epoxy alkane, such as 1,2-epoxy butane, ethylene oxide, or propylene oxide. The polyester curing agent (ii) can comprise an anhydride. Another suitable polyester comprises a lower 2-hydroxy-akylterminated poly-alkyleneglycol terephthalate.

In a particular embodiment, the polyester comprises at least one ester group per molecule in which the carbon atom adjacent to the esterified hydroxyl has a free hydroxyl group.

Also suitable is the tetrafunctional polyester prepared from the half-ester intermediate prepared by reacting trimellitic anhydride and propylene glycol (molar ratio 2:1), then reacting the intermediate with 1,2-epoxy butane and the glycidyl ester of branched monocarboxylic acids.

In one particular embodiment, where the active hydrogen-containing resin (i) comprises cationic salt groups, the polyester curing agent (ii) is substantially free of acid. For purposes of the present invention, by “substantially free of acid” is meant having less than 0.2 meq/g acid. For aqueous systems, for example for cathodic electrodepositable, coating compositions, suitable polyester curing agents can include non-acidic polyesters prepared from a polycarboxylic acid anhydride, one or more glycols, alcohols, glycol mono-ethers, polyols, and/or monoepoxides.

Suitable polycarboxylic anhydrides can include dicarboxylic acid anhydrides, such as succinic anhydride, phthalic anhydride, tetrahydrophthalic anhydride, trimellitic anhydride, hexahydrophthalic anhydride, methylhexahydrophthalic anhydride, 3,3′,4,4′-benzophenonetetracarboxylic dianhydride, and pyromellitic dianhydride. Mixtures of anhydrides can be used.

Suitable alcohols can include linear, cyclic or branched alcohols. The alcohols may be aliphatic, aromatic or araliphatic in nature. As used herein, the terms glycols and mono-epoxides are intended to include compounds containing not more than two alcohol groups per molecule which can be reacted with carboxylic acid or anhydride functions below the temperature of 150° C.

Suitable mono-epoxides can include glycidyl esters of branched monocarboxylic acids. Further, alkylene oxides, such as ethylene oxide or propylene oxide may be used. Suitable glycols can include, for example ethylene glycol and polyethylene glycols, propylene glycol and polypropylene glycols, and 1,6-hexanediol. Mixtures of glycols may be used.

Non-acidic polyesters can be prepared, for example, by reacting, in one or more steps, trimellitic anhydride (TMA) with glycidyl esters of branched monocarboxylic acids in a molar ratio of 1:1.5 to 1:3, if desired with the aid of an esterification catalyst such as stannous octoate or benzyl dimethyl amine, at temperatures of 50-150° C. Additionally, trimellitic anhydride can be reacted with 3 molar equivalents of a monoalcohol such as 2-ethylhexanol.

Alternatively, trimellitic anhydride (1 mol.) can be reacted first with a glycol or a glycol monoalkyl ether, such as ethylene glycol monobutyl ether in a molar ratio of 1:0.5 to 1:1, after which the product is allowed to react with 2 moles of glycidyl esters of branched monocarboxylic acids. Furthermore, the polycarboxylic acid anhydride i.e., those containing two or three carboxyl functions per molecule or a mixture of polycarboxylic acid anhydrides can be reacted simultaneously with a glycol, such as 1,6-hexane diol and/or glycol mono-ether and monoepoxide, after which the product can be reacted with mono-epoxides, if desired. For aqueous compositions these non-acid polyesters can also be modified with polyamines such as diethylene triamine to form amide polyesters. Such “amine-modified” polyesters may be incorporated in the linear or branched amine adducts described above to form self-curing amine adduct esters.

The non-acidic polyesters of the types described above typically are soluble in organic solvents, and typically can be mixed readily with the active hydrogen-containing resin (i) previously described.

Polyesters suitable for use in an aqueous system or mixtures of such materials disperse in water typically in the presence of resins comprising cationic or anionic salt groups such as any of those described previously.

A transesterification catalyst (iii) may optionally be present in the compositions used in the methods of the present invention. The catalyst (iii) can be any suitable catalyst known for catalysis of the transesterification reaction. In an embodiment of the present invention the catalyst (iii) comprises a metal oxide, metal complex or metal salt.

Suitable metal oxides include, for example, oxides of lead, bismuth, and tin, including dialkyltin oxides such as dioctyltin oxide or dibutyltin oxide. Alternatively, lead oxide and bismuth oxide can also be used when dissolved in an aqueous acid solution for example, an aqueous solution of a sulfonic acid.

Suitable salts may include carboxylate salts (for example, octoates or naphthenates) of lead, zinc, calcium, barium, iron, bismuth and tin, including dialkyltin dicarboxylates. Non-limiting examples of salts include lead octoate, zinc octoate, and dioctyltin formate. A suitable example of a metal complex is titanium acetyl acetonate.

Also suitable are salts e.g., octoates, and naphthenates, of the alkali and earth alkali metals, of the lanthanides, and of zirconium, cadmium, chromium; acetyl acetonate complexes of lead, zinc, cadmium, cerium, thorium, copper; alkali aluminium alcoholates and titanium tetraisopropoxide.

Mixtures of any of the salts, oxides and/or complexes described above can also be used.

In view of the varying metal content of available metal oxides, salts or complexes, or solutions thereof, the amount of catalyst may be indicated by the metal content contained in the compositions. Metal contents of 0.1 to 3.0 percent by weight are suitable, or metal contents of 0.3 to 1.6 percent by weight may be used, based on the total weight of the curable coating composition.

As mentioned above, the method of the present invention comprises: (a) applying any of the curable coating compositions described above to a substrate, (b) curing the coating composition to form a coating on the substrate, and (c) applying a conductive layer to all surfaces.

The substrate (or “core”) can comprise any of a variety of substrates. In one embodiment, the substrate is electrically conductive. Suitable electroconductive substrates can comprise metal substrates, for example, iron, aluminum, gold, nickel, copper, magnesium or alloys of any of the foregoing metals, as well as substrates coated with a conductive material, e.g., conductive carbon-coated materials. An example of a suitable iron-nickel alloy is INVAR, (trademark owned by Imphy S. A., 168 Rue de Rivoli, Paris, France) comprising approximately 64 weight percent iron and 36 weight percent nickel. This alloy has a low coefficient of thermal expansion, comparable to that of silicon materials used to prepare chips. This property is desirable for example to prevent failure of adhesive joints between successively larger or smaller scale layers of a chip scale package, due to thermal cycling during normal use. When a nickel-iron alloy is used as the electrically conductive core, a layer of copper metal can be applied to all surfaces of the electrically conductive core to ensure optimum conductivity. The layer of copper metal may be applied by conventional means, such as electroplating or metal vapor deposition. The layer of copper typically has a thickness of from 1 to 8 microns. In another embodiment, circuitized materials such as printed circuit boards are suitable as substrates.

The aforementioned coating compositions can be applied by a variety of application techniques well known in the art, for example, by roll-coating or spray application techniques. In such instances, the resinous binder may or may not include solubilizing or neutralizing acids and amines to form cationic and anionic salt groups, respectively.

Any of the previously described ionic group-containing compositions can be electrophoretically applied to an electroconductive substrate. The applied voltage for electrodeposition may be varied and can be, for example, as low as 1 volt to as high as several thousand volts, but typically between 50 and 500 volts. The current density is usually between 0.5 ampere and 5 amperes per square foot (0.5 to 5 milliamperes per square centimeter) and tends to decrease during electrodeposition indicating the formation of an insulating conformal film on all exposed surfaces of the core. As used herein and in the specification and in the claims, by “conformal” film or coating is meant a film or coating having a substantially uniform thickness which conforms to the substrate topography, including the surfaces within (but not occluding) any holes that may be present.

After the coating has been applied by an appropriate method, such as those mentioned above, it is cured. The coating can be cured at ambient temperatures or thermally cured. at elevated temperatures ranging from 90 to 300° C. for a period of 5 to 90 minutes to form a dielectric coating over the substrate.

The dielectric coating thickness can be no more than 50 microns, or no more than 25 microns, or no more than 20 microns.

Those skilled in the art would recognize that prior to the application of the dielectric coating, the core surface may be pretreated or otherwise prepared for the application of the dielectric coating. For example, cleaning, rinsing, and/or treatment with an adhesion promoter prior to application of the dielectric may be appropriate.

After application of the dielectric coating, the surface of the dielectric coating is optionally ablated in a predetermined pattern to expose sections of the substrate. Such ablation can be performed using a laser or by other conventional techniques, for example, mechanical drilling and chemical or plasma etching techniques.

A conductive layer can be applied to all surfacesafter the optional ablation step. The conductive layer may comprise a conductive paste or ink or metal.

Suitable conductive pastes and inks can include, for example, conductive silver coating copper pastes such as DD PASTE SAP510 and Conductor Ink P2000, respectfully, both of which are available from TATSUTA SYSTEM ELECTRONICS CO., LTD. Such materials can be applied by screen-printing techniques.

Suitable metals include copper or any metal or alloy with sufficient conductive properties. The conductive material can be applied by electroplating or any other suitable method known in the art to provide a uniform conductive layer. Alternatively, the conductive layer can be applied in a predetermined pattern, such as a circuit pattern. The thickness of this conductive layer can range from 1 to 50 microns, or from 5 to 25 microns. In the case where the dielectric coating is ablated prior to the application of the conductive layer, conductive or metallized vias are formed.

To enhance the adhesion of the conductive layer to the dielectric polymer, prior to the application of the conductive layer, all surfaces can be treated with ion beam, electron beam, corona discharge or plasma bombardment followed by application of an adhesion promoter layer to all surfaces. The adhesion promoter layer can range from 50 to 5000 angstroms thick and can be a metal or metal oxide selected from chromium, titanium, nickel, cobalt, cesium, iron, aluminum, copper, gold, tungsten, and zinc, and alloys and oxides thereof.

In a further embodiment, the method of the present invention also comprises: (d) applying a resist to the conductive layer applied in step (c), (e) processing said resist to form a predetermined pattern of exposed underlying conductive layer, (f) etching said exposed conductive layer, and (g) stripping the remaining second resist to form an electrical circuit pattern.

After application of the conductive layer, a resinous photosensitive layer (i.e. “photoresist” or “resist”) can be applied to the conductive layer. Optionally, prior to application of the photoresist, the coated substrate can be cleaned and/or pretreated; e.g., treated with an acid etchant to remove oxidized metal. The resinous photosensitive layer can be a positive or negative photoresist. The photoresist layer can have a thickness ranging from 1 to 50 microns, or 5 to 25 microns, and can be applied by any method known to those skilled in the photolithographic processing art. Additive or subtractive processing methods may be used to create the desired circuit patterns.

Suitable positive-acting photosensitive resins include any of those known to practitioners skilled in the art. Examples include dinitrobenzyl functional polymers such as those disclosed in U.S. Pat. No. 5,600,035, columns 3-15. Such resins have a high degree of photosensitivity. In one embodiment, the resinous photosensitive layer is a composition comprising a dinitrobenzyl functional polymer, typically applied by spraying.

In a separate embodiment, the resinous photosensitive layer comprises an electrodepositable composition comprising a dinitrobenzyl functional polyurethane and an epoxy-amine polymer such as that described in Examples 3-6 of U.S. Pat. No. 5,600,035.

Negative-acting photoresists include liquid or dry-film type compositions. Any of the previously described liquid compositions may be applied by spray, roll-coating, spin coating, curtain coating, screen coating, immersion coating, or electrodeposition application techniques. Preferably, liquid photoresists are applied by electrodeposition, more preferably cationic electrodeposition. Electrodepositable photoresist compositions comprise an ionic, polymeric material which may be cationic or anionic, and may be selected from polyesters, polyurethanes, acrylics, and polyepoxides. Examples of photoresists applied by anionic electrodeposition are shown in U.S. Pat. No. 3,738,835. Photoresists applied by cationic electrodeposition are described in U.S. Pat. No. 4,592,816. Examples of dry-film photoresists include those disclosed in U.S. Pat. Nos. 3,469,982, 4,378,264, and 4,343,885. Dry-film photoresists are typically laminated onto the surface such as by application of hot rollers.

Note that after application of the photosensitive layer, the multi-layer substrate may be packaged at this point allowing for transport and processing of any subsequent steps at a remote location.

In a separate embodiment of the invention, after the photosensitive layer is applied, a photo-mask having a desired pattern may be placed over the photosensitive layer and the layered substrate exposed to a sufficient level of a suitable radiation source, typically an actinic radiation source. As used herein, the term “sufficient level of radiation” refers to that level of radiation which polymerizes the monomers in the radiation-exposed areas in the case of negative acting resists, or which depolymerizes the polymer or renders the polymer more soluble in the case of positive acting resists. This results in a solubility differential between the radiation-exposed and radiation-shielded areas.

The photo-mask may be removed after exposure to the radiation source and the layered substrate developed using conventional developing solutions to remove more soluble portions of the photosensitive layer, and uncover selected areas of the underlying conductive layer. The conductive layer thus uncovered may then be etched using metal etchants which convert metal to water soluble metal complexes. The soluble complexes then may be removed by water spraying.

The photosensitive layer protects the underlying substrate during the etching step. The remaining photosensitive layer, which is impervious to the etchants, may then be removed by a chemical stripping process to provide a circuit pattern connected by the conductive vias.

After preparation of the circuit pattern on the multi-layered substrate, other circuit components may be attached to form a circuit assembly. Additional components include, for example, one or more smaller scale components such as semiconductor chips, interposer layers, larger scale circuit cards or mother boards and active or passive components. Note that interposers used in the preparation of the circuit assembly may be prepared using appropriate steps of the process of the present invention. Components may be attached using conventional adhesives, surface mount techniques, wire bonding or flip chip techniques.

Illustrating the invention are the following examples which are not to be considered as limiting the invention to their details. Unless otherwise indicated, all parts and percentages in the following examples, as well as throughout the specification, are by weight.

### EXAMPLES

The following examples illustrate the preparation of an electrodeposition coating and its use in the method for forming a circuit assembly according to the present invention.

### Example 1

The following example describes the synthesis of the cationic binder used in the electrodepositable coating bath described below. The binder was prepared from the following ingredients:

| | Parts by Weight |
|---|---|
| Ingredients | (in grams) |
| MAZON ® 1651¹ | 150.0 |
| EPON ® 880² | 755.3 |
| Tetrabromo bisphenol A | 694.9 |
| TETRONIC ® 150R1³ | 0.2857 |
| Aminopropyldiethanolamine | 114.7 |
| Diethanolamine | 49.57 |
| 2-Butoxyethanol | 832.4 |
| EPON 880 | 16.14 |
| Crosslinker⁴ | 1195 |

¹A plasticizer, commercially available from BASF Corporation.
²An epoxy resin available from Hexion Specialty Chemicals.
³A surfactant, commercially available from BASF Corporation.
³A polyester prepared according to Example V of EP 0 012 463, and diluted to 90% solids in 2-butoxyethanol.

The MAZON 1651, EPON 880, tetrabromobisphenol A and TETRONIC 150R1 were charged to a 4-neck round bottom flask fitted with a stirrer, temperature probe, and Dean-Stark trap under a Nitrogen blanket. The mixture was heated to a temperature of 70° C. and stirred for 15 minutes. The heat source then was removed, and the aminopropyldiethanolamine and diethanolamine were added. The reaction mixture exothermed to a maximum temperature of 176° C. after about 10 minutes. The reaction was allowed to cool to a temperature of 135° C. over an hour, the 2-butoxyethanol was added, and the mixture was further cooled to 125° C. The mixture was then held at 125° C. for a total of two hours from the peak exotherm. The second charge of EPON 880 and the crosslinker were added and the solution was stirred for one hour at 125° C. The reaction mixture (3428 parts) was poured into a solution of sulfamic acid (49.5 parts) dissolved in deionized water (1287 parts) under strong agitation. After one hour agitation, an additional amount of deionized water (3970 parts) was added slowly, yielding a dispersion having a 30.2% non-volatile content.

### Example 2

This example shows the preparation of an ungelled cationic soap used in the synthesis of the microgel example shown below. The cationic soap was prepared from the following ingredients:

| | Parts by Weight |
|---|---|
| Ingredients | (in grams) |
| EPON 828 | 1023 |
| Bisphenol A-ethylene oxide adduct¹ | 365 |
| Bisphenol A | 297 |
| 2-Butoxyethanol | 187.2 |
| Benzyldimethylamine | 1.4 |
| Benzyldimethylamine | 3.0 |
| Diketimine² | 182.3 |
| N-methylethanolamine | 85.2 |
| Acetic Acid | 105.9 |
| Deionized water | 1065.9 |
| Deionized water | 735.9 |
| Deionized water | 1156.4 |
| Deionized water | 867.3 |

¹A ⅙ molar adduct of bisphenol A/ethylene oxide available from BASF Surfactants.
²A 71 percent solution of the reaction product of diethylene triamine and methylisobutyl ketone in methylisobutyl ketone.

The EPON 828, bisphenol A-ethylene oxide adduct, bisphenol A and 2-butoxyethanol were charged into a reaction vessel and heated under a nitrogen atmosphere to a temperature of 125° C. The first portion of the benzyldimethylamine was added and the reaction was allowed to exotherm to 180° C. During the exotherm when the reaction reached 160° C., a one hour hold was begun. After the exotherm peak the resin was allowed to cool back to 160° C., continuing the hold. After the hold the reaction was cooled to 130° C., and the second portion of benzyldimethylamine was added. The reaction was held at 130° C. to an extrapolated epoxy equivalent weight of 1070. At the expected epoxy equivalent weight, the diketimine and N-methylethanolamine were added in succession and the mixture was allowed to exotherm to approximately 150° C. At the peak exotherm, a one hour hold was begun while allowing the reaction to cool to 125° C. After the one hour hold the resin was dispersed into a solution of the acetic acid dissolved in the first portion of deionized water. The dispersion was later reduced with the second, third, and fourth portions of deionized water. The resulting cationic soap was vacuum stripped until the methylisobutyl ketone level was less than 0.05%.

### Example 3

This example shows the synthesis of a cationic microgel from the cationic epoxy soap described above in Example 2. The microgel was prepared from the following ingredients:

| | Parts by |
|---|---|
| | Weight |
| Ingredients | (in grams) |
| Cationic soap of Example 2 | 2517 |
| Deionized water | 443 |
| EPON 828 (85% in methylisobutyl ketone) | 66.4 |
| Methylisobutyl ketone | 5.81 |
| Deionized water | 337 |

The deionized water was added to the cationic soap of Example 2, and the mixture was heated to 70° C. under a nitrogen blanket. The EPON 828 solution was added over 15 minutes with good agitation. The methylisobutyl ketone was added as a rinse, and the mixture was held at 70° C. for 45 minutes. The mixture was then heated to 90° C. over 70 minutes and held at this temperature for 3 hours with good mixing. The deionized water was then added and the mixture was cooled yielding a microgel dispersion at 18.9% non-volatile content.

### Electrodeposition Coating Bath and Coatings

### Example A

This example shows the preparation of a blend used to prepare the coating bath described below in Example D. The blend was prepared from the following ingredients:

| | Parts by |
|---|---|
| | Weight |
| Ingredients | (in grams) |
| Resin of Example 1 | 15748 |
| Ethylene glycol monohexyl ether | 540 |
| Deionized water | 2500 |

The electrodeposition resin of Example 1 was placed in a container under slow agitation. The ethyleneglycol monohexyl ether was added to this resin slowly under agitation and stirred for 30 minutes. The deionized water was then added to this mixture.

### Example B

This example shows the preparation of a second blend used to prepare the coating bath described below in Example D. The blend was prepared from the following ingredients:

| | Parts by |
|---|---|
| | Weight |
| Ingredients | (in grams) |
| E6278¹ | 203.7 |
| Deionized water | 203.7 |

¹Catalyst paste, available from PPG Industries, Inc.

The above ingredients were mixed under low agitation for 30 minutes.

### Example C

This example shows the preparation of a third blend used to prepare the coating bath described below in Example D. The blend was prepared from the following ingredients:

| | Parts by |
|---|---|
| | Weight |
| Ingredients | (in grams) |
| Additive of Example 2 | 3434 |
| Deionized water | 3434 |

The deionized water was slowly added to the additive of Example 2 under agitation. The mixture was stirred for one hour.

### Example D

The second blend of Example B was added to the blend of Example A under agitation. Deionized water (500 grams) was used to rinse the container used for the second blend of Example B into the agitated mixture. To this mixture was added the third blend of Example C, followed by two gallons of deionized water. This mixture was filtered through 3M oil sorbent cloth filters into a large (14 gallon) polypropylene tank.

Deionized water was added sufficient to fill the tank. Approximately 7 gallons of permeate was removed from the coating bath via ultrafiltration, the permeate being replaced with deionized water. The final pH and conductivity of the ultrafiltered paint were 5.65 and 765 microsiemens respectively. The measured solids of the tank (1 hour at 110° C.) was 10.25%.

### Example E

The electrodepositable coating composition of Example D was electrophoretically applied to copper foil (4 oz. TOB-III copper foil supplied by Oak-Mitsui, a division of Mitsui Kinzoko Corporate Group) from the electrodeposition bath at a temperature of 90° F. at 175 Volts for 3 minutes. The electrocoated foil was rinsed with deionized water and heated to a temperature of 240° C. for 30 minutes to cure the coating, thereby providing a cured dielectric film thickness of approximately 22 microns.

A 25 micron copper layer was deposited on the coating by the following process. The coating on the copper foil was activated by an oxygen plasma treatment followed immediately inline by a sputtered deposition of a Chromium adhesion layer and a copper seed layer. The thickness of copper was increased to approximately 25 microns by standard electrolytic copper plating.

Adhesion Testing: Adhesion of the copper layer to the dielectric was measured by 900 peel strength measurements as described in test method IPC-TM-650.2.4.9, “Peel Strength, Flexible Printed Wiring Materials”. To test the thermal stability of the coating and subsequent adhesion of the metallized layer to the coating, samples of the metallized, coated foils were placed in a forced air oven heated to 260° C. for three and six minutes. The peel strengths of the metallized layer to the coating before exposure and after three and six minutes in the heated environment are listed in Table 1. A reduction in peel strength occurred after three minutes heat exposure, however no further reduction was measured with increased time. No cracking, popping or blistering defects at either the metallized copper-dielectric coating or dielectric coating-copper foil interfaces occurred at any time during the thermal testing.

TABLE 1
Peel strength of copper-dielectric interface

| Before heat exposure | 3 minutes at 260° C. | 6 minutes at 260° C. |
|---|---|---|
| 6.4 | 5.2 | 5.2 |

Whereas particular embodiments of this invention have been described above for purposes of illustration, it will be evident to those skilled in the art that numerous variations of the details of the present invention may be made without departure from the invention as defined in the appended claims.

Therefore we claim:

1. A method for preparing a circuit assembly comprising:
(a) applying a curable coating composition to a substrate, said curable coating composition comprising:
(i) one or more active hydrogen-containing resins,
(ii) one or more polyester curing agents, and
(iii) optionally one or more transesterification catalysts,
(b) curing said curable coating composition to form a coating on the substrate; and
(c) applying a conductive layer to the surface of at least part of said cured composition.

2. The method of claim 1, further comprising:
(d) applying a resist to the conductive layer applied in step (c);
(e) processing said resist to form a predetermined pattern of exposed underlying conductive layer;
(f) etching said exposed conductive layer; and
(g) stripping the remaining second resist to form an electrical circuit pattern.

3. The method of claim 1, wherein the coating composition comprises covalently bonded halogen.

4. The method of claim 3, wherein said covalently bonded halogen content ranges from 1 to 50 weight percent based on total weight of resin solids present in said coating composition.

5. The method of claim 1, wherein the active hydrogen-containing resin (i) is derived from at least one of a polyepoxide polymer and an acrylic polymer.

6. The method of claim 3, wherein the resin (i) has a covalently bonded halogen content derived from a halogenated polyepoxide and/or a halogenated acrylic polymer.

7. The method of claim 6, wherein the covalently bonded halogen present in the resin (i) is derived from a halogenated polyhydric phenol.

8. The method of claim 7, wherein the halogenated polyhydric phenol comprises at least one of chlorinated bisphenol A and brominated bisphenol A.

9. The method of claim 8, wherein the halogenated polyhydric phenol comprises tetrabromobisphenol A.

10. The method of claim 1, wherein said active hydrogen-containing resin (i) comprises cationic salt groups.

11. The method of claim 10, wherein said coating composition is electrodepositable.

12. The method of claim 1, wherein said polyester (ii) comprises a polyester of a polycarboxylic acid having more than one ester group per molecule.

13. The method of claim 12, wherein said polyester (ii) is substantially free of acid.

14. The method of claim 12, wherein said polyester (ii) comprises at least one ester group per molecule in which the carbon atom adjacent to the esterified hydroxyl has a free hydroxyl group.

15. The method of claim 1, wherein said transesterification catalyst comprises a metal oxide, metal salt or metal complex.

16. The method of claim 15, wherein the metal oxide, metal salt and/or metal complex are derived from a metal selected from tin, bismuth and lead.

17. The method of claim 1, wherein said substrate is electrically conductive.

18. The method of claim 1, wherein said substrate comprises a metal selected from copper, an iron-nickel alloy and combinations thereof.

19. The method of claim 1, wherein said conductive layer applied in step (c) is copper.

20. A circuit assembly prepared by the method of claim 2.
